(19) United States
(12) Patent Application Publication
(10) Pub. No.: US 2011/0162217 A1
(43) Pub. Date: Jul. 7, 2011

(54) Compact knife holder

(76) Inventors: Semyon Rabinovich, Basking Ridge, NJ (US); Michael Rabinovich, Solon, OH (US)

(21) Appl. No.: 12/655,701

(22) Filed: Jan. 7, 2010

(51) Int. Cl. B26B 27/00

(52) U.S. Cl. 30/298.4

(57) ABSTRACT

The invention proposes a wall-mounted knife holder, which comprises a pack of several plates separated by narrow and thin strips as spacers. The space between two successive strips forms a channel for the knife blade. The rows of channels in any two adjacent pairs of plates crisscross each other but the plates are stacked, the crisscrossed channels do not intersect, and the knives using these channels do not touch each other. At the same time, knives in all the rows utilize the same space on a wall surface, which makes the knife holder compact. The holder is attached to a wall so that the channels from both sides are at an angle that ensures that the force of gravity holds the knives in the channels. The front plate of the holder can be made from a decorative material and adorned with beatifying design.

### BACKGROUND OF THE INVENTION

The invention concerns the household items, specifically the devices for storing knives used in houses and apartments.

Knife blocks are widely used in kitchens in residential housing; these blocks are sold, either in a set with the knives or separately. A drawback of knife blocks is that they occupy space on a kitchen table or counter, where free space is typically scarce. Thus, many households forgo knife blocks and keep their knives in kitchen drawers along with other utensils. This practice creates a danger of getting an accidental cut when selecting an item from the drawer. Further the knives in a drawer are prone to blunt against other metal items. There are knife blocks that can be placed in the drawers but these blocks take up the entire drawer, which again wastes premium kitchen space that can usually be utilized more efficiently for other purposes. Thus, drawer-placed blocks have found limited acceptance.

Many patents exist for knife holders and knife racks that are wall mounted, for example, U.S. Pat. Nos. 768,266; 1,876,284; 2,459,391; 2,955,789; 5,011,102; 5,050,749. However, these blocks do not find usage in residential kitchens because of their large size and industrial appearance. In particular, a magnetic wall mounted knife holder made by Würsthof is commercially available. This holder, in addition to the above-mentioned drawbacks, is also unsafe: it leaves the knife blades open and does not exclude a possibility that a knife may fall off due to an accidental disturbance and hurt a person's foot or get damaged.

### SUMMARY OF THE INVENTION

This invention proposes a new wall-mounted knife holder, which comprises a pack of several plates separated by narrow and thin strips as spacers. The strips separating a given pair of plates run preferably in parallel from one edge of the two plates to the other. The space between two parallel strips forms a channel for the knife blade. Furthermore, the strips separating any two adjacent pairs of plates run across each other thus forming crisscrossed channels. For example, a pack of three plates forms two plate-pairs and two rows of parallel channels. Channels in one row crisscross channels in the other row but because they belong in different planes in space they do not intersect. Thus, knives using these channels do not touch each other.

The holder is attached to a wall so that the channels from both sides are at an angle that ensures that the force of gravity, working with the strips, holds the knives securely in the channels. The front plate of the holder can be made from a decorative material and adorned with various ornaments or other beatifying design.

The presented knife holder has the following advantages over known wall-mounted holders:
1. The knife blades in the holder are fully concealed and thus the holder is safe.
2. The knives are inserted into the holder from two sides so that the handles of all knives are unblocked and equally accessible.
3. The knives in the holder are physically separated into two groups allowing a reliable separation of the knives, e.g., the knives for prepared food from those for raw meats as recommended by hygienic considerations, or the knives used for meats from those used for cheeses as demanded in Jewish observances.
4. The wall space occupied by the knife holder is not wasted because the front plate could be used to attach hooks for other kitchen items such as towels, brushes, sponges, etc. Or alternatively, this plate can be used for a photograph, a picture, or another beatifying item.
5. The front plate, made, e.g., from polished wood or other decorative material, can become a design element that not only does not clash with but also beautifies residential kitchen appearance.
6. The presented holder can be quite thin and thus does not protrude appreciably from the wall on which it is mounted. For example, a two-raw holder can be less than 25 mm thick (two 5 mm plates, one 7 mm plate, and two rows of 3 mm spacer strips).

### BRIEF DESCRIPTION OF THE DRAWINGS

FIG. 1 is a front elevation view of a knife holder made in accordance with the present invention, which is shown holding 2 knives, one from each side.

FIG. 2 is a front elevation view of a knife holder made in accordance with the present invention, which has one row of channels on each side.

FIG. 3 is a front view of the middle plate with attached spacer strips.

FIG. 4 is a front view of the back (wall-adjacent) plate with attached spacer strips.

FIG. 5 is a photo of a prototype knife holder made in accordance with the present invention.

### DESCRIPTION OF THE PREFERRED EMBODIMENT

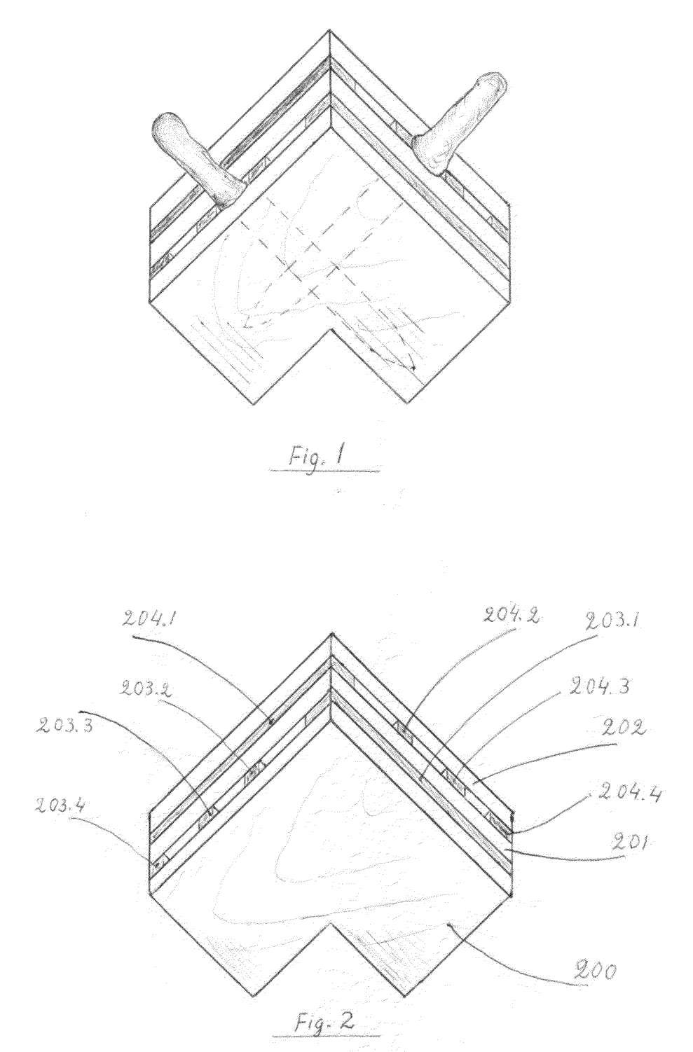

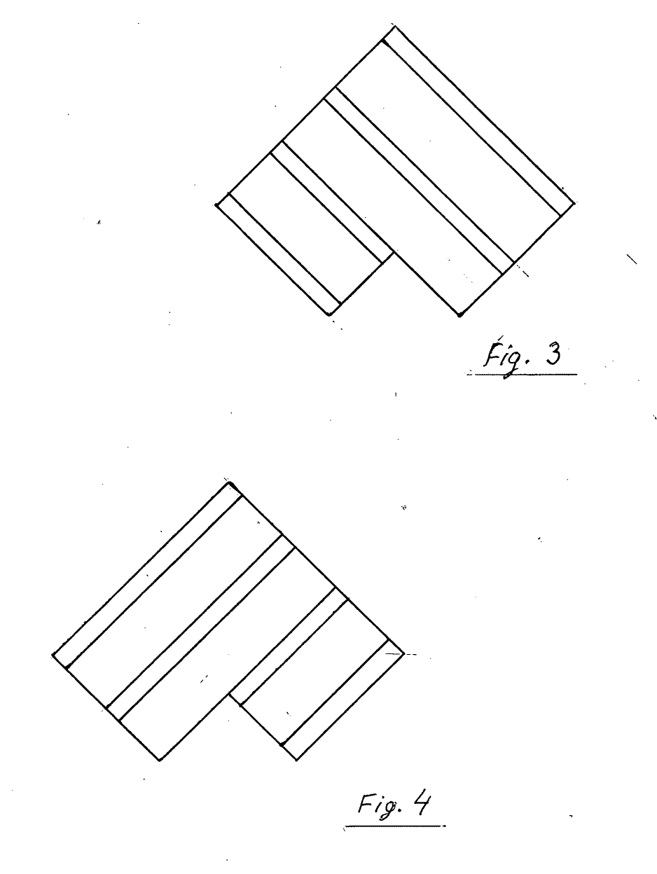

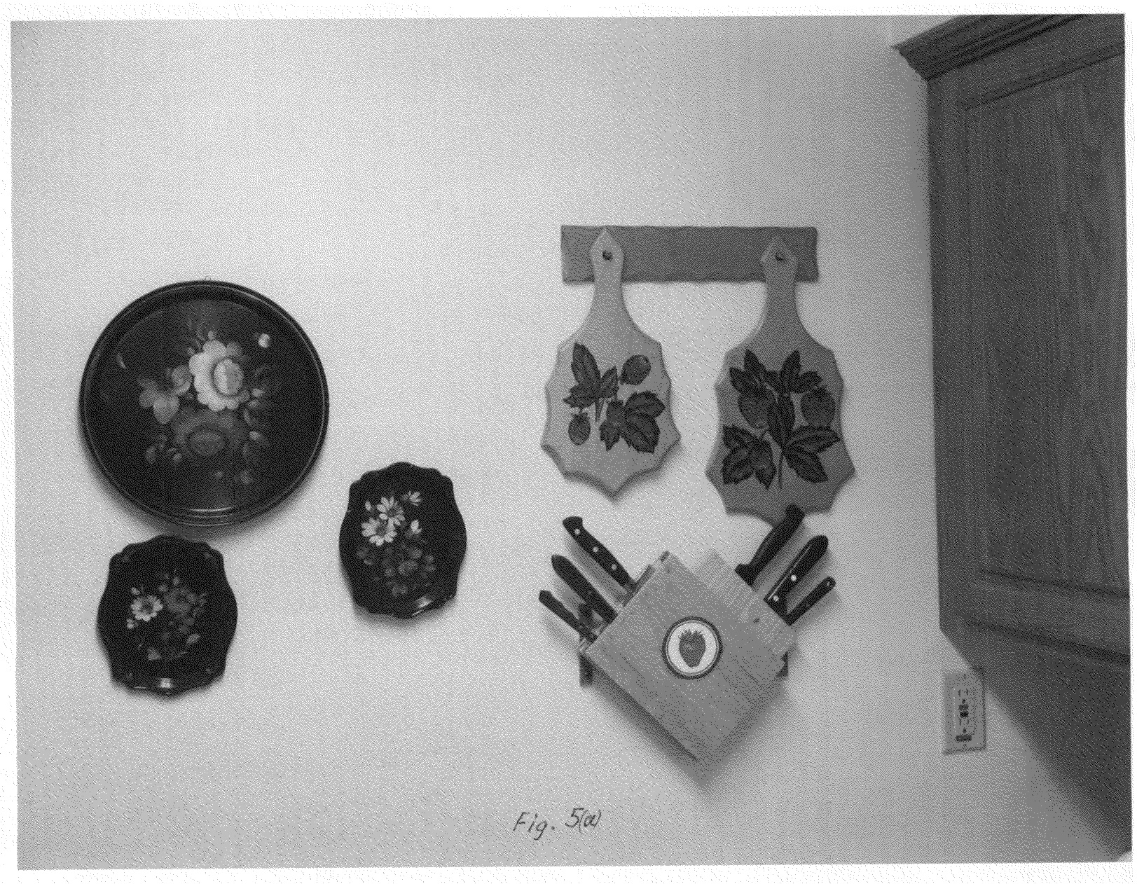

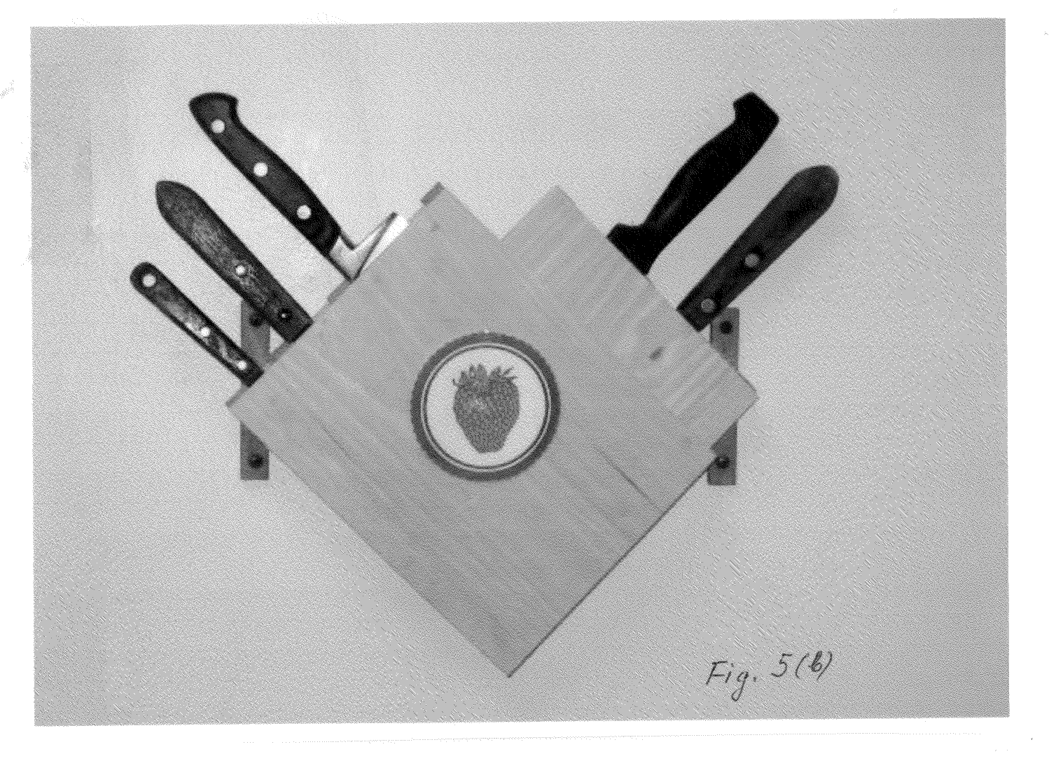

FIG. 1 shows an overall view of the knife holder made in accordance with the present invention. It shows two knives inserted into the holder from each side. FIG. 2 clarifies the design of the holder made in accordance with the present invention. It shows two rows of channels from each side of the holder. The holder consists of three plates 5, 6, and 7, and two rows of spacer strips, 8 and 9, between these plates. In the embodiment described, all plates have the same shape, which is shown in FIGS. 3 and 4. To the plates 7 and 6 are glued narrow and thin spacer strips, although it should be understood that strips could be glued to either one of their adjacent plates. In this embodiment, the strips on each plate run from one edge of the plate to the other; however in another embodiment it might be desirable to make the strips protrude outside the edges of the plates so that the protruding ends of the strips provide easy guidance to the user as to where to insert the knives into the holder. FIGS. 3 and 4 give the front view of the middle and the last plates from the side where the strips are attached. Thanks to the spacer strips, when the plates are composed into a pack, through channels are formed. One row of channels is formed between the plates 5 and 6, and the other between the places 6 and 7. As the result, one row of channels is situated closer to the front panel than the other row of channels, and the knives in each row are reliably separated by plate 6.

Unlike other plates, the back plate 7 must have thickness of at least half that of the thickest knife handle.

The attachment of the strips to the plates can be done with glue, screws, or staples or any other permanent means.

The components listed above, attached to each other, form the knife holder. The holder has through channels into which the knives are inserted from two sides. The open bottom side of the channels prevents the accumulation of dust and allows for easy cleaning of the channels.

The size of the plates (and hence the holder) is determined by the length of the knives to be stored in it, and the space between spacer strips in the same row (e.g., the width of the channels) is determined by the width of the knives. In the embodiment shown in FIG. 2, the channels for long knives are situated in the upper part of the holder, while the channels for short knives are in the bottom part. This makes the bottom parts of the plates empty and they can be removed. In FIG. 2, this removed part of the plates is made in the shape of a square, but it can follow a different design, e.g., following a section of a circle or another shape.

A person skilled in the art will appreciate that the described invention allows for wide variety of designs. The channels in the holder can be formed by means other than the spacer strips; for example, they can be formed by cutting out depressions from the plates. The pack of plates can have not three but a greater number of plates; the plates can have different shapes as long as the angles of the channels are sufficient for their steady positioning in the holder. A single holder may also incorporate a wide variety of channel lengths and widths.

The plates of the holder can be made of wood, plywood, molded plastic, composite materials, metal, or other material, and one pack may include plates made of different materials. The space strips must be made from a material that is less hard than the knife blades such as wood or plastic of similar density so that the blades would not blunt when touching the strips.

The holder is mounted on a wall in a way that the channels from both sides are at an angle to the horizontal line that ensures that the force of gravity, by pressing the knives against the spacer strips, holds the knives securely in the channels. In the preferred embodiment, the mounting positions the channels on both sides at the same angle to the horizontal line. Wall mounting can be done in any way used to mount shelves on the walls. A simple way is to make the wall-side plate slightly larger than the rest of the pack. Then this plate can be fitted with a few holes for screws. Because the plate is larger than the rest of the pack, these screws will be easily accessible and can be used to conveniently attach the holder to the wall.

The front plate can be laminated or made from decorative wood or material, turning the knife holder into a accessory accent of the kitchen interior design.

The holder can be retailed in a disassembled form, and a kit to be glued together by the consumer. This would allow the consumer to customize the channel widths to correspond to the specific knives to be stored in the holder.

In mass production of the holder described in the present invention, some of the internal plates can be made without spacers, while other plates would be made with spacers from both sides. For example, on FIG. 2, the holder has one internal plate 6 with spacers on one side. Instead, this plate could have spacers on both sides, and then neither the front nor the back plates would have any attached spacers. Such a plate with spacers on both sides can be pressed from plastic or other moldable or pressable material as one unit.

The inventor has implemented a prototype of the knife holder according to the current invention, and its photograph is shown in FIG. 5. The prototype has been in actual use and confirmed all advantages of the present invention.

We claim:

1. A wall-mounted knife holder comprising sets of channels organized in such a way that channels in some sets crisscross channels in other sets and where crisscrossed channels run in different planes and thus do not intersect with each other.

2. A knife holder of claim 1 where channels are formed by a set of plates separated by spacers and assembled into a pack in such as way that
a. The channels in neighboring plate-pairs crisscross each other;
b. When the holder is mounted in the working position, every channels run at an angle to the horizontal line that ensures that the force of gravity holds the knives securely in the channels.

3. A knife holder of claim 1 where channels or groups of channels are fully isolated from every other channel or group of channels so that the knives stored in different channels or groups of channels cannot get in contact with each other.

4. A knife holder of claim 3 where isolated channels or channel groups are marked for knives of distinct use.

5. A knife holder of claim 2 where the spacers are attached to one of the adjacent plates.

6. A knife holder of claim 5 where the plate and its attached spacers are manufactured as one unit.

7. A knife holder of claim 2 where spacers forming channels in two neighboring plate-pairs are attached to the two sides of the middle plate that the two plate-pairs have in common.

8. A knife holder of claim 7 where the plate and its attached spacers are manufactured as one unit.

9. A knife holder of claim 2 where channels are formed by depressions cut out from the corresponding plates.

10. A knife holder of claim 2 where spacers protrude beyond the edge of the plates.

11. A knife holder of claim 2 where the front plate is made decoratively attractive by means of special materials, finishing, or design.

12. A knife holder of claim 2 where one or several hooks or other holders are attached to the front plate to be used to keep various kitchenware or other items.
